(19) United States
(12) Patent Application Publication
(10) Pub. No.: US 2009/0154386 A1
(43) Pub. Date: Jun. 18, 2009

(54) WIMAX MULTICAST BROADCAST SERVICES (MBS) EFFICIENT HANDOVER AND POWER SAVING SUPPORT FOR INTRA AND INTER-MBS ZONES

(76) Inventors: Tricci SO, San Diego, CA (US); Jerry Chow, San Diego, CA (US); Song Jian Quan, Shenzhen (CN); Chu Li, Shenzhen (CN)

Correspondence Address: MORRISON & FOERSTER LLP, 12531 HIGH BLUFF DRIVE, SUITE 100, SAN DIEGO, CA, 92130-2040, US

(21) Appl. No.: 12/338,928

(22) Filed: Dec. 18, 2008

Related U.S. Application Data
(60) Provisional application No. 61/014,573, filed on Dec. 18, 2007.
(60) Provisional application No. 61/023,400, filed on Jan. 24, 2008.
(60) Provisional application No. 61/027,289, filed on Feb. 8, 2008.
(60) Provisional application No. 61/029,271, filed on Feb. 15, 2008.

(51) Int. Cl. H04H 20/71; H04W 36/00; G08C 17/00

(52) U.S. Cl. 370/311; 370/312; 370/331

(57) ABSTRACT

A broadcast management message includes MBS Zone Neighbor information to associate different MBS Zones which transmit the same MBS contents over a single frequency or a different frequency. An MBS Zone Service Group contains a group of MBS Zones that transmit the same MBS content over the same frequency or at different frequencies. All the MBS Zones that belong to the same MBS Zone Service Group may have the same MBS Zone Service Group Identifier (ID).

### RELATED PATENT APPLICATIONS

This application claims benefit of priority under 35 U.S.C. § 119(e) to Provisional Application No. 61/014,573, entitled “WiMAX Multicast Broadcast Services (MBS) Efficient Handover and Power Saving Support for Inter-MBS Zones and Inter-Frequency”, filed Dec. 18, 2007; Provisional Application No. 61/023,400, entitled “WiMAX Multicast Broadcast Services (MBS) Efficient Handover and Power Saving Support for Inter-MBS Zones and Inter-Frequency”, filed Jan. 24, 2008; Provisional Application No. 61/027,289, entitled “WiMAX Multicast Broadcast Services (MBS) Efficient Handover and Power Saving Support for Inter-MBS Zones and Inter-Frequency”, filed Feb. 8, 2008; Provisional Application No. 61/029,271, entitled “WiMAX Multicast Broadcast Services (MBS) Efficient Handover and Power Saving Support for Intra and Inter-MBS Zones”, filed Feb. 15, 2008, all of which are incorporated by reference herein in their entirety.

### FIELD OF THE INVENTION

The present invention relates to wireless networks, and more particularly, to a system and method for providing a multicast and broadcast service (MBS) in a WiMAX network.

### BACKGROUND OF THE INVENTION

The support of multicast and broadcast services (MBS) is emerging as a major new feature in broadband wireless standards, such as IEEE 802.16/WiMAX. The latest version of the IEEE 802.16 standard, which includes the 802.16e amendment and is referred to as ‘the 802.16e standard’ or as ‘the 802.16e-2005 specification’ herein, has introduced support for multicast and broadcast services (MBS) in its air interface specification.

The 802.16e standard defines a specific mode of multicast and broadcast operation where the same MBS traffic is sent simultaneously from a group of base stations (BSs). This mode of MBS operation is referred to as multi-BS MBS and this grouping of BSs is called an MBS Zone. The synchronized simultaneous transmission of the same MBS traffic from the BSs in an MBS Zone on a single carrier frequency provides the performance benefits gained via spatial macro-diversity.

A mobile station (MS) that wishes to start reception of particular MBS content over the air interface does so by setting up an MBS Media Access Control (MAC) connection with its serving BS. During the connection setup procedure, the MS is assigned the ID of the MBS MAC connection (known as a Multicast Connection ID, or MCID) to be used for reception of the subscribed content within a specific MBS Zone identified by an MBS Zone ID.

MBS traffic signals for multi-BS MBS connections are sent from the BS as data bursts within major time partitions in the downlink (DL) part of the MAC frame. These time partitions of the frame are referred to as permutation zones as they are distinguished by how subcarriers of the Orthogonal Frequency Division Multiplexed (OFDM) signal are distributed and grouped into subchannels. In another words, an MBS permutation zone is essentially a time partition within the frames that contains MBS data. A permutation zone may contain one or more MBS data bursts, and an MBS data burst may contain one or more MAC Protocol Data Units (PDUs).

As defined by the 802.16e standard, when operating with the OFDM Access (OFDMA) physical layer, the BSs transmit resource allocation information to the MSs through Media Access Protocol (MAP) messages that reside at the beginning of the downlink part of the frame. The MAP message used for transmitting downlink resource allocation information is the downlink-MAP (DL-MAP) message. The DL_MAP message includes various information elements (IEs) that contain MAC frame control information. In particular, an MBS_MAP_IE may be present in the DL MAP message of a frame that specifies where an MBS permutation zone (or MBS data) starts within the frame.

The MBS_MAP_IE specifies the starting point of an MBS permutation zone. The exact details of the MBS permutation zone, including the structure, modulation and coding of MAC data bursts within the MBS permutation zone, are described in an MBS MAP message. If present, an MBS MAP message always resides as the first data burst within an MBS permutation zone. The MBS MAP message contains Information Elements (IEs) that describe the individual MBS data bursts that are present in MAC frames that are 2 to 5 frames in the future from the frame that contains the MBS MAP message itself. These IEs may be MBS_DATA_IE, Extended-MBS_DATA_IE, or MBS_DATA_Time_Diversity_IE. The MBS MAP message may also contain an IE that describes the next occurrence of an MBS MAP message containing the next occurrence of a data burst for the MBS connection.

When an MS has successfully established a specific multi-BS MBS MAC connection, it begins searching the DL MAP messages of the successive frames until it finds the first MBS_MAP_IE that describes the location of the next MBS permutation zone for the MBS Zone that the MBS MAC connection belongs to. The beginning of that MBS permutation zone should contain an MBS MAP message.

On finding an MBS MAP message that contains a data burst allocation for an applicable MBS connection, the MS is provided sufficient information to locate, demodulate and decode the MBS data burst, and in addition, to locate the next occurrence of an MBS MAP message containing the next occurrence of a data burst for the MBS connection. Thus, once the MS finds an MBS MAP message, it knows how to find the next MBS MAP message.

This latter feature (that is, the daisy-chaining from an MBS MAP message to the next MBS MAP message(s) pertaining to the same MBS connections) enables efficient power saving operation when the MS is not otherwise active except to occasionally receive applicable MBS content because the MS is not required to continually monitor the DL MAP message of each frame searching for the next MBS MAP message for an applicable MBS connection.

In today's IEEE 802.16e-2005 specification for Multicast Broadcast Services (MBS), the design of the handover and power saving support for Multi-BS MBS, which leverages the daisy-chain mechanism provided by MBS_DATA_IE, is limited to the mobile stations (MSs) that are associated with the same MBS Zone. An MBS Zone is composed of one or more Base-Stations (BSs) belonging to the same geographical region of which the BSs synchronize their downlink transmission with the same data contents over the same or different frequencies to a set of target mobile stations or to any mobile station in that region.

Due to the physical properties of the radio frequency (RF) propagation and the consequently induced multipath delay, the coverage area of the MBS Zone is limited. To enable large geographical coverage of the MBS services, multiple MBS Zones transmitting the same MBS content are required to support the Multi-BS MBS service. As a result, it is necessary for the MS to maintain MBS service continuity across multiple MBS Zones. The different MBS Zones transmitting the same MBS content may or may not be using the same frequency or the same carrier.

For a given MBS Zone's RF resource allocation, the reserved permutation zone for MBS bursts, which is described by the MBS_MAP message and is identified by an MBS Zone Identifier (ID), supports the same set of Multicast Connection Identifiers (MCIDs)—i.e. one or more MCIDs. All MSs registered with the same MBS Zone also establish connectivity to receive the MBS Zone downlink transmission from one or more of this set of MCIDs. The location of the reserved permutation zone of the MBS burst is pointed out by the MBS_MAP_IE in the DL-MAP message.

As the MBS Zone ID and MCID remain the same, the MS can refer to the same burst profile of the Downlink (DL) subframes that are synchronously transmitted by the BSs belonging to the same MBS Zone to receive the MBS DL transmission. In addition, the MBS_DATA_IE, which is part of the MBS_MAP message, provides the support to daisy-chain the data transmissions of the given MBS service across multiple DL frames which do not immediately follow each other in a consecutive manner. With MBS_DATA_IE support, there is no need to search for the MBS_MAP_IE in every frame to locate the MBS burst for the given MBS Zone.

Such a mechanism provides a more efficient MBS handover support for the MS without the need of MCID update when the MS is moving from one BS to another BS, when compared to the unicast handover operation. Additionally, such a mechanism also allows the MS to enter in-and-out of the power saving mode (e.g., idle mode) without the need of re-establishing the MCID(s) in order to resume the reception of the MBS DL transmission from the new serving BS.

However, the operation described above cannot be preserved between MBS Zones according to the current IEEE 802.16e-2005 specification. When the MS is crossing MBS Zones (i.e., those having different MBS Zone IDs), which may or may not use the same carrier, the preservation of the same MCID can no longer be guaranteed.

As a result, when the MS is crossing the MBS Zone, the MS is required to obtain the new MBS Zone ID and the MCID(s) by performing connection re-establishment and a new look up of the MBS_MAP_IE information in order to locate the new MBS burst of the new MBS Zone to resume the reception of the MBS DL transmission. Thus, the current operation is time and radio resource inefficient.

Thus, one problem associated with today's IEEE 802.16e-2005 specification for multi-BS MBS support is that, when the MS is crossing the MBS Zones in active or power saving modes, the MBS service continuity cannot be maintained unless the MS executes a time consuming procedure such as handover or idle-mode re-entry to obtain the new MBS Zone and the associated MBS MCID in order to resume the reception of the MBS downlink transmission. Such a procedure could introduce significant packet loss and consume additional power.

Therefore, there is a need for an improved method and system that efficiently maintain MBS service continuity when the MS is crossing the MBS Zones in active or power saving modes.

### SUMMARY OF THE INVENTION

To compensate for today's IEEE 802.16e-2005 specification to support an efficient Multi-BS MBS inter MBS-Zone and inter frequency handover and power saving, embodiments of the invention provide a new broadcast WiMAX management message, i.e., MBS Zone Neighbor Advertisement, that includes “MBS Zone Neighbor” information to associate a given MBS Zone with different neighbor MBS Zones which transmit the same MBS contents over a single frequency or a different frequencies.

In one embodiment of the invention, a method for providing a multicast and broadcast service (MBS) in a wireless network is provided. The method comprises connecting a first MBS MAC connection (MCID) between a given mobile station (MS) and a first base station (BS) in a first MBS Zone identified by a first MBS Zone ID; the given MS together with a group of MSs which prescribe the same MBS contents are all receiving MBS Zone neighbor information associating the first MBS Zone with a group of neighbor MBS Zones identified by a group of MBS Zone IDs from the first BS, wherein the first MBS Zone and the neighbor MBS Zones comprise the same MBS content; selecting a neighbor base station (BS) in the any of the neighbor MBS zones; connecting a second MBS MAC connection between the given MS and the neighbor BS.

To enable today's IEEE 802.16e procedure to support an efficient Multi-BS MBS intra and inter MBS-Zone handover and power saving protocol, one embodiment of the invention provides an MBS Zone Service Group which contains a group of MBS Zones that transmit the same MBS content over the same frequency or at different frequencies.

In one embodiment, all the MBS Zones that belong to the same MBS Zone Service Group within the same MBS Transmission Zone will have the same MBS Zone Service Group Identifier (ID). The MBS Zone Service Group ID together with the MBS Zone ID uniquely identify a given MBS Zone transmitting MBS content to a group of subscribers who are prescribed to the same multicast or broadcast services.

In another embodiment, the MBS Zone Service Group ID is also advertised or broadcast in the Downlink Channel Descriptor (DCD) as well as in the DCD Neighbor Advertisement messages. As a result, when the MS recognizes that the old serving MBS Zone changed for the newly attached BS, the MS can easily derive the new serving MBS Zone and the corresponding MBS Zone ID.

In yet another embodiment, the MBS Zone Service Group corresponds to an MBS Service Area or MBS Transmission Zone announced by the content service provider's electronic Service Guide (ESG). Once the MS is prescribed to the desired MBS services and receives the ESG, it can then tune into the proper MBS Zone to wait for the reception of the expected MBS programming.

### BRIEF DESCRIPTION OF THE DRAWINGS

FIG. 1 illustrates a flow chart for an exemplary MBS operation in active mode and power saving mode according to several embodiments of the present invention.

FIG. 2 illustrates two MBS Zone Service Groups with their associated MBS Zones in accordance with one embodiment of the present invention.

FIG. 3 illustrates the concept of MBS Zone neighbors in accordance with one embodiment of the present invention.

### DESCRIPTION OF EXEMPLARY EMBODIMENTS OF THE INVENTION

In the following description of exemplary embodiments, reference is made to the accompanying drawings which form a part hereof, and in which it is shown by way of illustration of specific embodiments in which the invention may be practiced. It is to be understood that other embodiments may be utilized and structural changes may be made without departing from the scope of the preferred embodiments of the invention.

The present invention is directed to an improved method and system that efficiently maintain MBS service continuity when the MS is crossing the MBS Zones in active or power saving mode. Embodiments of the invention are described herein in the context of one practical application, namely, communication between a base station and a plurality of mobile devices. In this context, the example system is applicable to provide data communications between the base station and the plurality of mobile devices. The invention, however, is not limited to such base station and mobile device communications applications, and the methods described herein may also be utilized in other applications such as mobile-to-mobile communications, wireless local loop communications, wireless relay communications, or wireless backhaul communications, for example. Furthermore, although embodiments of the present invention are described herein in terms of a WiMAX network, it should be understood that the present invention is not limited to this application, but is generally applicable to any wireless network.

To compensate for today's IEEE 802.16e-2005 specification to support an efficient Multi-BS MBS intra and inter MBS-Zone handover and power saving operations, embodiments of the invention are directed to a new broadcast WiMAX management message, i.e., MBS Zone Neighbor Advertisement (MBS_NBR_ADV), that includes new “MBS Zone Neighbor” information to associate different MBS Zones which transmit the same MBS contents over a single frequency or different frequencies.

In order to conserve the air link usage to advertise the MBS Zone Neighbor, not all the MBS Zones and their corresponding MBS Zone neighbors will advertise all at once in a single subframe. Embodiments of the invention are directed to a distributed MBS Zone Neighbor Advertisement broadcast message to be spread across multiple frames.

The following describes how to leverage the “MBS Zone Neighbor” and/or “MBS Zone Neighbor Advertisement” broadcast message to enhance MBS operations according to one or more embodiments of the invention.

One aspect of the present invention relates to handover operation within or across the MBS zones. To minimize the service performance impact and to enhance the user experience, during the handover operation when the MS is crossing the MBS Zone or frequency zone, in one embodiment, the serving BS informs the MS of the possible target MBS Zone ID(s) and the corresponding MCID(s) that the MS can handover to if service continuity is needed for the given MBS contents. The same mechanism is applied to both the MS-initiated or network-initiated handover operation.

In addition, one embodiment of the invention preserves the same MCID(s) in the target MBS Zone so that there is no need to pass on the new MCID(s) to the MS. In another embodiment, the new MCID is included in the MBS Zone Neighbor Information to notify the MS.

In one embodiment, the serving BS recommends the potential HO target BS(s) to the MS to perform the handover procedure with the MCID update in order to retrieve the new MBS Zone ID and new MCID(s) that support the same MBS contents. The same mechanism is applied to both the MS-initiated or network-initiated handover operation. In one embodiment, the same security association (SA) remains the same across the MBS Zones which are associated with each other to carry the same MBS contents. Nevertheless, the SA information can also be included in the HO context transfer.

Another aspect of the present invention relates to power saving support with and across the MBS Zones. While the MS is entering in-and-out of the idle mode, it is also possible for the MS to cross the MBS Zone boundary or frequency zone boundary. One embodiment is to have the MS to perform the Location Update to retrieve the current serving BS's MBS Zone ID and the corresponding MCID(s) that support the same MBS contents. Other embodiments of the invention provide ways to advertise the MBS Zone Neighbor Information in a new broadcast MBS management message to the MS. The MBS Zone Neighbor Information contains the list of MBS Zones that are associated with the MS's current MBS Zone and carry the same MBS contents. Therefore, the MS is not required to perform the Location Update during the idle mode in order to retrieve the new target MBS Zone ID and the corresponding MCID(s) to resume the reception of the MBS contents.

In one embodiment, the Downlink Configuration Descriptor (DCD) in the frame header posted by the new serving BS indicates which MBS Zone that the new serving BS is supporting. If the MBS Zone of the new serving BS does not match the MBS Zone that the MS has previously registered, the MS refers to the MBS Zone Neighbor Information to determine the new target MBS Zone that the current serving BS is supporting to locate the MBS burst and to resume the reception of MBS DL transmission from the new serving BS.

In addition, one embodiment of the invention also provides ways to preserve the same MCID(s) in the target MBS Zone so that there is no need to include the new MCID(s) in the MBS Zone Neighbor Information. In another embodiment, the new MCID(s) is included in the MBS Zone Neighbor Information and is advertised by the serving BS in the broadcast MBS Neighbor Zone advertisement to notify the MS.

In one embodiment, the security association (SA) remains the same across the MBS Zones that are associated with each other to carry the same MBS contents. Nevertheless, the SA information can also be included in the HO context transfer.

The present invention also utilizes the concept of the “distributed” MBS Zone Neighbor Advertisement. In accordance with embodiments of the present invention, the MBS Zone Neighbor Advertisement broadcast Management message is spread across multiple frames.

In one embodiment, the distributed MBS Zone Neighbor Advertisement message advertises each MBS Zone's neighbors at least once within 255 frames. The reason that 255 frames is chosen is because the MBS_Data_IE supports daisy-chaining the current DL subframe to the next DL subframe at most 255 frames apart. With this approach, the given WiMAX system can determine how often and how many MBS Zone neighbors to be advertised across 255 frames. However, the implementation decision on how to distribute the MBS Zone Neighbor information across 255 frame shall be a network deployment decision—i.e., it shall be based on the consideration of how to balance the optimization on the resource allocation and the performance of the MS to discover the required MBS Zone neighbors.

In one embodiment, if the current subframe contains the transmission of a given MBS zone, the same subframe must also advertise the neighbors of the given MBS zone. However, additional MBS Zone Neighbor advertisement of the other MBS zone is also permitted.

In one embodiment, if the MS cannot determine its current MBS Zone's neighbors after the 255 frames (this is possible if, e.g., the MS has moved away from its MBS Zone Neighborhood), the MS performs the regular Location Update to obtain the new MBS Zone assignment information and the corresponding neighbor. The acknowledgement of the Location Update (i.e. RNG-RSP) from the network to the MS includes the newly assigned MBS Zone Information for the MS and the associated MBS Zone Neighbor Information.

To leverage this broadcast MBS Zone Neighbor Advertisement management message over the airlink, there are two main power-saving scenarios to consider.

In the first scenario, the MS enters in-and-out of the power saving mode during the MBS downlink transmission session which is still active.

If the transmission session is active, the daisy-chain can support the pre-scheduled future frame up to 255 frames apart from the current frame. When considering 255 frames of a 5 msec frame, the elapse time is about 1.3 seconds. In a macro cell environment, even if the MS is traveling in full speed, within 1.3 seconds, it is likely that the MS has traveled only one BS or at most two BSs away from the previous BS.

When the MS enters idle mode, the MS should have the knowledge of the current MBS Zone's neighbor due to the MBS Zone Neighbor advertisement.

When the MS gets ready to receive the upcoming MBS downlink transmission contents, the MS would have known the MBS Zone Neighbor when comparing to the current MBS Zone via the periodic MBS Zone Neighbor Advertisement message from the serving BS or via periodic broadcast of MBS_MAP message which contains also the MBS Zone Neighbor information

In the second scenario, there is no active MBS downlink transmission for the MS. However, the next MBS downlink transmission session will be resumed for the upcoming MBS data as described in the schedule of the MBS programming guide.

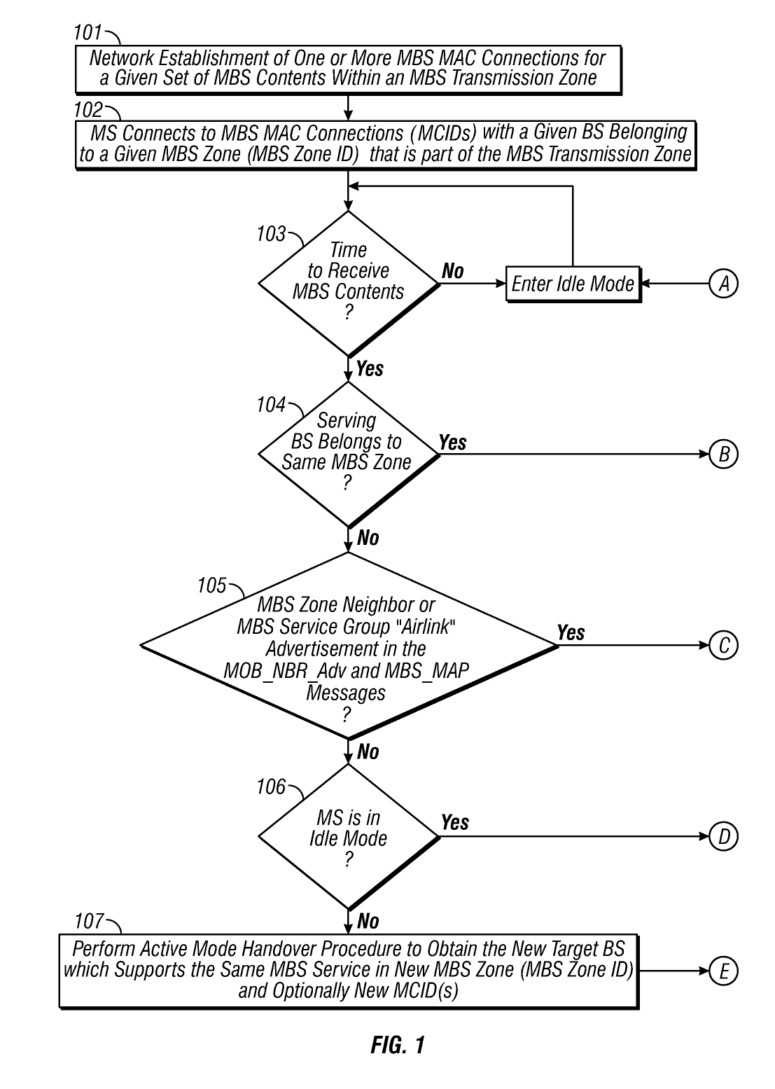

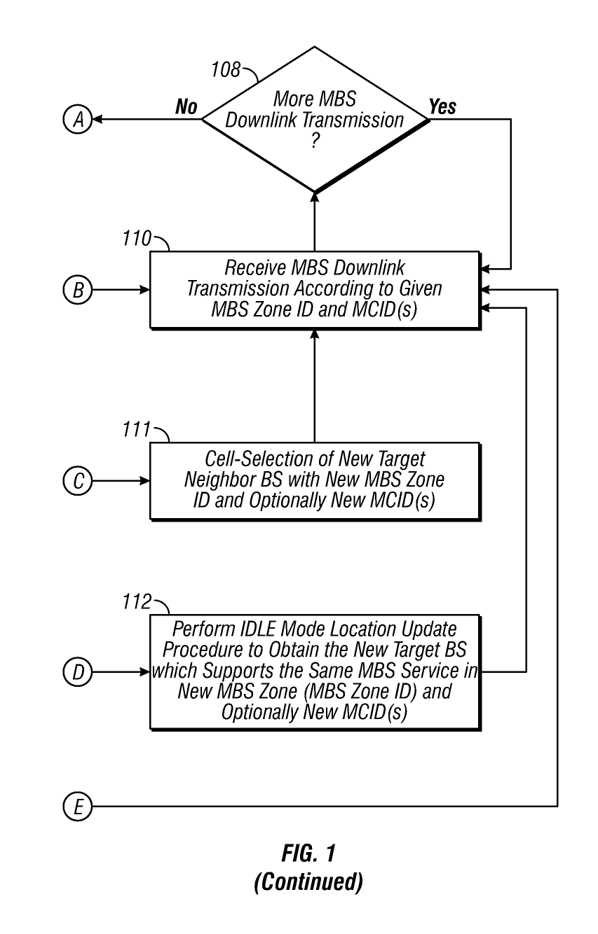

FIG. 1 illustrates a flow chart for an exemplary MBS operation in active mode and power saving mode according to several embodiments of the present invention. As shown in FIG. 1, in step 101, the network establishes the MBS MAC connection to be shared by the MSs connecting to the same MBS contents. In step 102, the MS connects to the MBS MAC connection that is shared by all MSs with the serving BS for the given MBS contents. In step 103, the MS determines if there is any active MBS downlink transmission at this time. If there is scheduled MBS downlink transmission, and, in step 104, if the serving BS belongs to the same serving MBS Zone that serves the MS, the MS will receive the MBS downlink transmission from the serving BS as in step 110. However, in step 103, if it is determined that there is no schedule MBS downlink transmission, the MS enters the idle mode as in step 109.

In Step 104, if the serving BS does not belong to the same serving MBS Zone that serves the MS, and if broadcast MBS Zone Neighbor Advertisement is supported as described in step 105, the MS will then select the target neighbor BS which supports the neighbor MBS Zone as described in step 111. However, if the broadcast MBS Zone Neighbor Advertisement is not supported as described in step 105, and if the MS is in active mode as described in step 106, the MS will have to perform the handover procedure as in step 107 to obtain the new target MBS Zone and the corresponding MCID(s). However, if the MS is in idle mode as described in step 106, the MS will have to perform the location update procedure as in step 112 to obtain the new target MBS Zone and the corresponding MCID(s).

In step 104, when the MS comes from the power saving mode and discovers that the current attached BS does not belong to the same MBS Zone, the MS should wait for the next frame to look for its MBS Zone neighbor in step 105. If after the 255 frames, the MS still cannot determine which one of the neighbor MBS Zones the MS belongs to, the MS can implement the regular Location Update operation to find out the new MBS Zone ID and the corresponding MBS Zone neighbors in step 106 after it recognizes the MS is in the idle mode. The acknowledgement of the Location Update (i.e., RNG-RSP) from the network to the MS can include the newly assigned MBS Zone Information for the MS and the associated MBS Zone Neighbor Information.

If the MS exits idle mode not only for getting ready to receive the MBS data, but also to prevent idle timer timeout, the MS executes the regular Location Update procedure. When complete, the MS also obtains the new MBS Zone ID information as well as the corresponding MBS Zone's neighbors.

To enable today's IEEE 802.16e procedure to support an efficient Multi-BS MBS intra and inter MBS-Zone handover and power saving protocol, one embodiment of the invention provides an MBS Zone service Group which contains a group of MBS Zones that transmit the same MBS content over the same frequency or at different frequencies.

In one embodiment, all the MBS Zones that belong to the same MBS Zone Service Group will have the same MBS Zone Service Group Identifier (ID). The MBS Zone Service Group ID together with the MBS Zone ID uniquely identify a given MBS Zone transmitting MBS content to a group of registered (in the case of multicast services) or unregistered (in the case of broadcast services) subscribers.

In a further embodiment, the MBS Zone Service Group ID may also advertised or broadcast in the Downlink Channel Descriptor (DCD) as well as in the DCD Neighbor Advertisement (MOB_NBR_ADV) messages. As a result, when the MS recognizes that the old serving MBS Zone changed for the newly attached BS, the MS can easily derive the new serving MBS Zone and the corresponding MBS Zone ID.

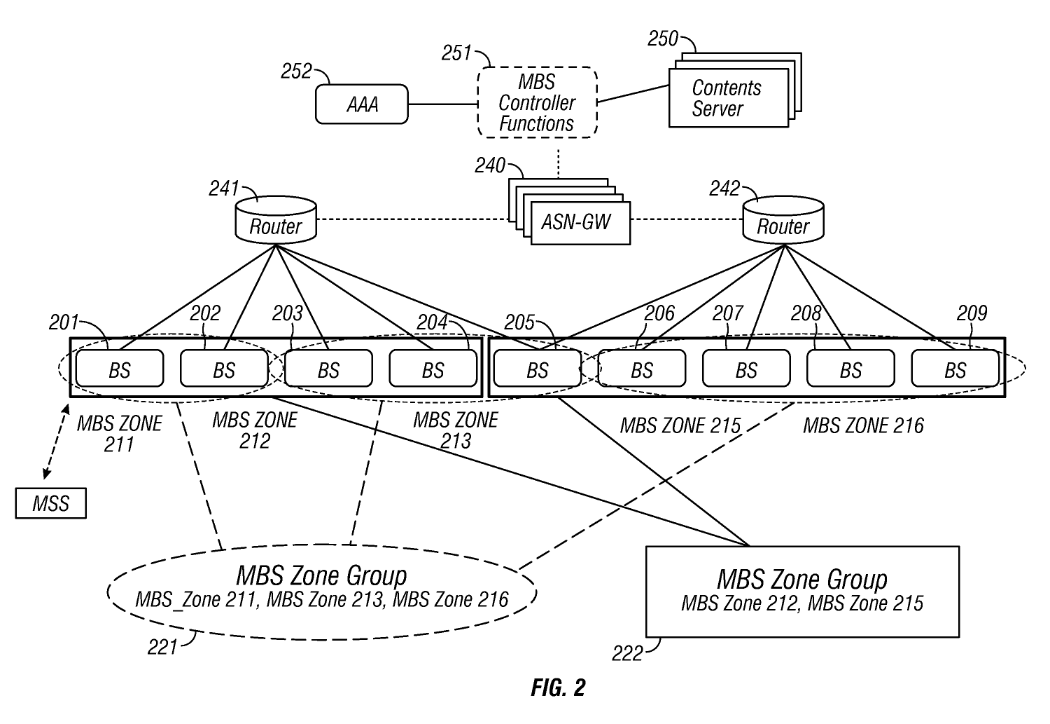

FIG. 2 illustrates two MBS Zone Service Groups with their associated MBS Zones in accordance with one embodiment of the invention. As shown in FIG. 2, BSs 201, 202, 203, 204, 205, 207, 208 and 209 are organized into five MBS Zones 211, 212, 213, 215 and 216. Each BS can participate in multiple MBS Zones. For example, BS 201 is a member of both MBS Zones 211 and 212. The MBS Zones are grouped into two MBS Service Groups. MBS Zones 211, 213 and 216 are grouped into MBS Zone Service Group 221; while MBS Zones 212 and 215 are grouped into MBS Zone Service Group 222. In accordance with one embodiment of the present invention, each MBS Zone participates in only one MBS Zone Service Group. As shown in FIG. 2, the geographical coverage area of an MBS Zone Service Group can be much larger than that of an individual MBS Zone.

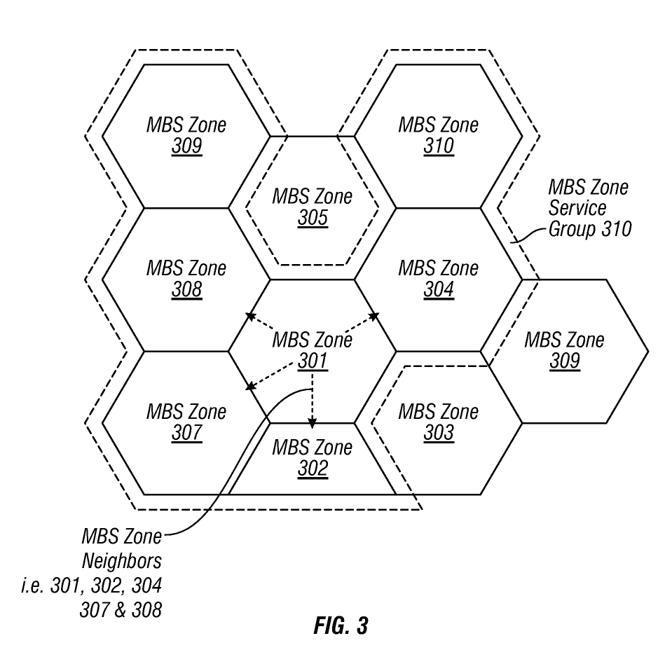

FIG. 3 illustrates the concept of MBS Zone neighbors in accordance with one embodiment of the present invention. As shown in FIG. 3, MBS Zone 301 is surrounded by a plurality of MBS Zones covering the adjacent geographical areas. MBS Zones 302, 304, 307 and 308 provide the same MBS Services as MBS Zone 301, and they constitute the MBS Zone neighbors of the MBS Zone 301. MBS Zones 301, 302, 304, 307 and 308 forms the MBS Zone Service Group 310, which may corresponds to an MBS Transmission Zone, or an MBS Service Area. As shown in FIG. 3, the geographical coverage area of MBS Zone Service Group 301 is much larger than that of MBS Zone 301.

The following describes how to leverage the MBS Zone Service Group with its associated MBS Zones to enhance the MBS operations while the MS is at active or power saving mode, in accordance with one embodiment of the invention.

While an active MS is crossing the MBS Zones, to minimize the service performance impact and to enhance the user experience, prior to the MS crossing the MBS Zone, the existing mechanism for the MS can be reused to obtain the BS's DCD information and the MOB_NBR_ADV neighbor information advertisement airlink message that includes the MBS Zone Service Group ID and the MBS Zone ID. By recognizing the MBS Zone Service Group ID, the MS can then derive the associated MBS Zone ID and the associated MCID(s) of the target BS that the MS is going to crossover and/or handover to. In particular, during the handover (HO) operation, the Handover Request (HO-REQ) message includes the target BS that supports the MBS Zone belonging to the same MBS Zone Service Group. The MS will then be able to extract the new target MBS Zone and the associated MCID(s) from the broadcast message and to resume the reception of the MBS content downlink transmission immediately over the airlink without waiting for the handover or the location update procedures to complete.

Additionally, in one embodiment, the same MCID(s) in the newly selected target BS within the target MBS Zone are preserved so that less information is required to be broadcast over the airlink; and precious airlink resources are conserved.

While the MS is entering in-and-out of the idle mode, it is also possible for the MS to cross the MBS Zone boundary. Rather than always having the MS perform the location update or the network re-entry to obtain the new target MBS Zone and new MCID(s) information, in one embodiment, the invention leverages the same procedure and protocol as described above in connection with the handover procedure. Thus, in one embodiment, the MBS Zone Service Group Information advertised in the DCD and MOB_NBR_ADV neighbor information advertisement is used so that the MS can derive the target MBS Zone ID and possibly the associated MCID(s) to obtain the same MBS content from the new target BS.

As described in the various exemplary embodiments above, the invention provides an extension to support an efficient intra and inter MBS-Zone handover and power saving protocol, which allows the continuation of the use of the MBS_MAP_IE, MBS_MAP message, MBS_DATA_IE, Extended_MBS_DATA_IE and MBS_DATA_Time_Diversity_IE. In various embodiments, the invention can also eliminate the overhead of the network re-entry latency and minimize the intra and inter MBS-Zone handover and network re-entry delay.

In a further embodiment, the invention supports the usage scenario when the content service provider's electronic Service Guide (ESG) announces the Multicast/Broadcast Service Area of the MBS service. Such Service Area perfectly maps to the MBS Zone Service Group. As a result, once the MS registers to the desired MBS services and receives the ESG, it can then tune into the proper MBS Zone to wait for the reception of the expected MBS programming.

While various embodiments of the present invention have been described above, it should be understood that they have been presented by way of example only, and not of limitation. Likewise, the above figure may depict an example architecture or configuration for the invention, which is done to aid in understanding the features and functionality that can be included in the invention. The invention is not restricted to the illustrated architecture or configuration, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

What is claimed is:

1. A method for providing a multicast and broadcast service (MBS) in a wireless network, the method comprising:
connecting a first MBS MAC connection between a mobile station (MS) and a first base station (BS) in a first MBS Zone identified by a first MBS Zone ID;
the MS receiving MBS Zone neighbor information associating the first MBS Zone with a second MBS Zone identified by a second MBS Zone ID, wherein the first MBS Zone and the second MBS Zone comprise the same MBS content;
selecting a second base station (BS) in the second MBS zone; and
connecting a second MBS MAC connection between the MS and the second BS.

2. The method of claim 1, wherein the MBS Zone neighbor information comprises the second MBS Zone ID.

3. The method of claim 2, further comprising the second BS transmitting MBS Zone neighbor information to the first BS.

4. The method of claim 3, wherein the MBS Zone neighbor information is included in a broadcast management message.

5. The method of claim 4, wherein the first MBS MAC connection is associated with a first Multicast Connection Identifier (MCID).

6. The method of claim of 5, wherein the second MBS MAC connection is associated with the first MCID.

7. The method of claim of 5, wherein the MBS Zone neighbor information comprises a second MCID.

8. The method of claim of 7, wherein the second MBS MAC connection is associated with the second MCID.

9. The method of claim of 4, wherein the first MBS Zone and the second MBS Zone comprise the same security association.

10. The method of claim of 4, wherein the MBS Zone neighbor information comprises a security association associated with the second MBS Zone.

11. The method of claim 4, wherein the first MBS Zone is the same as the second MBS Zone, and the first BS and the second BS transmit data on different frequencies.

12. The method of claim 4, further comprising the second BS transmitting the broadcast management message to the first BS at least once within 255 frames.

13. The method of claim 4, further comprising the second BS transmitting the broadcast management message to the first BS repeatedly at a fixed interval.

14. The method of claim 4, further comprising the MS receiving MBS data bursts in a first frame from the first BS.

15. The method of claim 14, wherein the first frame comprises the MBS Zone neighbor information in a subframe containing MBS data bursts.

16. The method of claim 14, further comprising the MS receiving MBS data bursts in a second frame from the second BS without searching for an MBS_MAP_IE in the second frame.

17. The method of claim 16, further comprising the MS performing a handover operation to establish connection to the second BS.

18. The method of claim 17, wherein the handover operation is MS-initiated.

19. The method of claim 17, wherein the handover operation is network-initiated.

20. The method of claim 16, further comprising the MS entering into a power saving mode after receiving the first frame, and exiting the power saving mode before receiving the second frame.

21. The method of claim 4, further comprising the MS entering into a power saving mode.

22. The method of claim 21, further comprising the MS exiting the power saving mode to determine whether it is attached to a BS in the first MBS Zone.

23. The method of claim 22, further comprising the MS exiting the power saving mode to determine whether it is attached to a BS in the second MBS Zone.

24. A method for providing a multicast and broadcast service (MBS) in a wireless network, the method comprising:
providing a first MBS Zone comprising at least a first Base Station (BS), the first MBS Zone being identified by a first MBS Zone ID;
providing a second MBS Zone comprising at least a second Base Station (BS), the second MBS Zone being identified by a second MBS Zone ID, wherein the first MBS Zone and the second MBS Zone comprise the same MBS content; and
transmitting MBS Zone neighbor information associating the first MBS Zone with the second MBS Zone.

25. The method of claim 24, wherein the MBS Zone neighbor information comprises the second MBS Zone ID.

26. The method of claim 25, further comprising the second BS transmitting MBS Zone neighbor information to the first BS.

27. The method of claim 26, wherein the MBS Zone neighbor information is included in a broadcast management message.

28. The method of claim 27, wherein the MBS Zone neighbor information comprises an MBS MAC connection Identifier (MCID).

29. The method of claim of 27, wherein the MBS Zone neighbor information comprises a security association.

30. The method of claim 27, wherein the first MBS Zone is the same as the second MBS Zone, and the first BS and the second BS transmit data on different frequencies.

31. The method of claim 27, further comprising the second BS transmitting the broadcast management message to the first BS at least once within 255 frames.

32. The method of claim 27, further comprising the second BS transmitting the broadcast management message to the first BS repeatedly at a fixed interval.

33. A method for providing a multicast and broadcast service (MBS) in a wireless network, the method comprising:
connecting a first MBS MAC connection between a mobile station (MS) and a first base station (BS) in a first MBS Zone identified by a first MBS Zone ID, the first MBS Zone and a second BS Zone identified by a second MBS Zone ID comprise the same MBS content and belong to an MBS Zone Service Group identified with an MBS Zone Service Group ID;
the MS receiving the MBS Zone Service Group ID in a broadcast management message;
selecting a second base station (BS) in the second MBS zone;
the MS determining the second MBS Zone ID; and
connecting a second MBS MAC connection between the MS and the second BS.

34. The method of claim 33, further comprising the MS receiving MBS Zone Service Group information.

35. The method of claim 34, wherein the MS receives the MBS Zone Service Group information in an Electronic Service Guide (ESG) announcing an MBS Service Area, and the MBS Zone Service Group corresponds to the MBS Service Area.

36. The method of claim 34, wherein the MBS Zone Service Group corresponds to an MBS Transmission Zone.

37. The method of claim 33, wherein the broadcast management message is a Downlink Channel Descriptor (DCD) message.

38. The method of claim 26, wherein the broadcast management message is a Neighbor Advertisement (MOB_NBR_ADV) message.

39. The method of claim 26, wherein the first MBS MAC connection and the second MBS MAC connection are associated with the same Multicast Connection Identifier (MCID).

40. The method of claim of 26, wherein the first MBS MAC connection and the second MBS MAC connection support the same set of logical channels.

41. The method of claim of 26, wherein the first MBS Zone and the second MBS Zone comprise the same security association.

42. The method of claim 26, further comprising the MS receiving MBS data bursts in a first frame from the first BS.

43. The method of claim 42, further comprising the MS receiving MBS data bursts in a second frame from the second BS without searching for an MBS_MAP_IE in the second frame.

44. The method of claim 43, further comprising the MS performing a handover operation to establish connection to the second BS.

45. The method of claim 44, wherein the handover operation is MS-initiated.

46. The method of claim 44, wherein the handover operation is network-initiated.

47. The method of claim 44, further comprising transmitting the MBS Zone Service Group ID in a Handover Request (HO-REQ) message.

48. The method of claim 44, further comprising transmitting the MBS Zone Service Group ID in a Handover Response (HO-RSP) message.

49. The method of claim 43, further comprising the MS entering into a power saving mode after receiving the first frame, and exiting the power saving mode before receiving the second frame.

50. A method for providing a multicast and broadcast service (MBS) in a wireless network, the method comprising:
providing a first MBS Zone comprising at least a first Base Station (BS), the first MBS Zone being identified by a first MBS Zone ID;
providing a second MBS Zone comprising at least a second Base Station (BS), the second MBS Zone being identified by a second MBS Zone ID, wherein the first MBS Zone and the second MBS Zone comprise the same MBS content and belong to an MBS Zone Service Group identified with an MBS Zone Service Group ID; and
transmitting the MBS Zone Service Group ID in a broadcast management message.

51. The method of claim 50, further transmitting MBS Zone Service Group information.

52. The method of claim 51, wherein the MBS Zone Service Group information is included in an Electronic Service Guide (ESG) announcing an MBS Service Area, and the MBS Zone Service Group corresponds to the MBS Service Area.

53. The method of claim 51, wherein the MBS Zone Service Group corresponds to an MBS Transmission Zone.

54. The method of claim 50, wherein the broadcast management message is a Downlink Channel Descriptor (DCD) message.

55. The method of claim 50, wherein the broadcast management message is a Neighbor Advertisement (MOB_NBR_ADV) message.

56. The method of claim 50, further comprising transmitting the MBS Zone Service Group ID in a Handover Request (HO-REQ) message.

57. The method of claim 50, further comprising transmitting the MBS Zone Service Group ID in a Handover Response (HO-RSP) message.
